(19) United States
(12) Patent Application Publication
(10) Pub. No.: US 2025/0312923 A1
(43) Pub. Date: Oct. 9, 2025

(54) ROBOTIC TAPPING SYSTEM FOR ELECTRIC ARC FURNACE

(71) Applicant: MOMEK TAPPINGMATE AS., Mo i Rana (NO)

(72) Inventors: Alexander Johansen, Mo i Rana (NO); Bjørn Audun Risøy, Mo i Rana (NO)

(73) Assignee: MOMEK TAPPINGMATE AS, Mo i Rana (NO)

(21) Appl. No.: 18/865,425

(22) PCT Filed: May 22, 2023
(86) PCT No.: PCT/NO2023/050120

§ 371 Date: Nov. 13, 2024

(30) Foreign Application Priority Data
May 20, 2022 (NO) 20220600

(51) Int. Cl. B25J 9/16; B25J 13/08; B25J 15/00; F27B 3/19; F27D 3/15

(52) U.S. Cl. CPC B25J 9/1697; B25J 13/089; B25J 15/0019; F27B 3/19; F27D 3/1509

(57) ABSTRACT

A system and method for robotic tapping of rotating furnaces is provided.

The present invention attains the above-described objective by a robot that uses a coarse positioning system to align roughly with the tap hole and a fine positioning system using optical alignment for fine positioning before operating a tool for opening, maintaining or plugging the tap hole.

### BACKGROUND OF THE INVENTION

### Field of the Invention

The invention relates to a rotating electric arc furnace system in general and more specifically a system and a method for robotic tapping and maintaining of furnaces.

### Background

Furnaces for melting metal are drained when extracting the liquid metal. This is done by opening existing tap holes in the furnace wall. The opening process is mainly done by means of a drill, but an oxygen lance is also frequently used in the last part of the opening procedure. During tapping, the hole may need to be maintained, and also temporarily plugged when making minor repairs of e.g. the ladle, before reopening again.

In most cases oxygen lancing is a manual operation where an operator wearing protective clothing is in the furnace hall, holds an oxygen lance in his hands and burns open the hole with the lance. At the same time there is enormous heat from the melt at 2000 C, and sparks, metal droplets and smoke. The process relies on the expertise of human operators. Nevertheless, 6 m long oxygen lances are difficult to use properly, even for experts, and therefore the holes may not be optimally maintained.

For many FeSi ovens, the rotation of the furnace makes it impossible to have a fixed position for entering the oxygen lance into the tapping hole. Furthermore, an electric furnace involves large electric currents and magnetic fields that also pose challenges. These factors also cause problems in maintaining the geometry of the tapping hole, and the unintended wear can change the gradient and also cause a trumpet shaped tapping bore over time. The changes in the geometry of the tapping hole will over time damage the liner surrounding the area where the tapping hole should be. Precise drilling operation (angle and position) and limited lancing operations will increase the lifetime of the furnace.

Operation on any electrical furnace gives strict demands for electrical isolations and barriers to prevent the electrical potential of the furnace to be conducted towards building earth. Any unintentional electric connection between furnace and building earth makes electrical ground fault, risk of fire, risk of personnel injury, risk of equipment damage, and potential equipment down-time.

Presently, the refining takes place inside the furnace. There are some experiments where further processing takes place in the ladle, by adding oxygen into the bottom of the ladle while adding material, fining, from the top. This technology is not mature and the process causes smoke and sparks, that in turn leads to poor visibility and makes the operation hazardous for any operators nearby.

Equipment service in electrical furnaces is a demanding task. The large and heavy equipment in use is placed in narrow areas, making it complicated to take e.g. a drilling rig out of the area for maintenance.

State of the art is reflected in small, fixed position taphole furnaces using robots. For large or rotating furnaces, one has not been able to adapt robots for use in this environment. State of the art for these types of furnaces are large, specialised machines with manual positioning in front of the tap hole.

From prior art one should refer to US 20070145648 A1, which according to the abstract relates to a robot system and/or method for the discharge of slag and/or matte from smelting furnaces.

EP2136172 relates to a furnace with a bay panel, as well as a measurement device.

CN108051249 relates to a molten sampling robot for the casting industry.

WO0053987 relates to a method for triggering casting in a light-arc furnace, the arc furnace comprising a bell-shaped end wherein is located a taphole of said furnace.

CN 107514912 A relates to smelting equipment, in particular to a high-temperature furnace operating device.

KR101372726 B1 discloses an apparatus for centering hole drilling machine.

CA3090600 A1 discloses according to the abstract, a displaceable robot for performing operations using a tool near a high temperature furnace containing molten metal, wherein the robot is displaceable using a vehicle.

There is therefore a need for a method and a system to overcome the above-mentioned problems.

### SUMMARY OF THE INVENTION

### Problems to Be Solved by the Invention

It is therefore, the main objective of the present invention to provide a robotic tapping system for electric arc furnaces. The tapping system should be a flexible system operating all the main tools needed for the furnace operation, making it possible to minimize the time the operator has to spend in the dangerous area.

The system should be a game changer for easy operation and maintenance of electrical arc furnaces. The system is built upon modules that can be swapped on short notice. Further on, the robot can serve as a service tool by lifting a tool out of the tapping area and onto e.g. a truck or crane.

### Means for Solving the Problems

The objective is achieved according to the invention by a robot system for operating a rotating arc furnace as defined in the preamble of claim 1, having the features of the characterising portion of claim 1, and a method for operating a robot system as defined in the preamble of claim 5, having the features of the characterising portion of claim 5.

A number of non-exhaustive embodiments, variants or alternatives of the invention are defined by the dependent claims.

The present invention attains the above-described objective by a robot that uses a coarse positioning system to align roughly with the tap hole and a fine positioning system using optical alignment for fine positioning before operating a tool for opening, maintaining or plugging the tap hole. The fine positioning system comprises an optical system on the robot and a target mark positioned on the furnace, wherein an optical recognition system determines the optimal position of the tap hole to be drilled. The system is capable of calculating the taphole position, desired tool position and entry vector in an environment with high electrical and magnetic disturbance.

### Effects of the Invention

The present invention comprises a technological advantage over known systems and methods by use of robot operations for opening, tapping, plugging, and maintaining tapping of furnaces. This provides far greater precision in operation of the tap hole.

These effects provide in turn several further advantageous effects:
it makes it possible to standardise and automate the process
it reduces the risk of damage on personnel and equipment
it saves cost by reducing manual labour cost it reduces energy consumption and loss of alloys and metals
it reduces emissions of NOX and CO₂ to the atmosphere
it increases the lifespan of the furnace, due to a more predictive drilling and lancing operation.
It lowers equipment cost/maintenance, most parts are off the shelf standardized equipment.

### BRIEF DESCRIPTION OF THE DRAWINGS

The above and further features of the invention are set forth with particularity in the appended claims and together with advantages thereof will become clearer from consideration of the following detailed description of an [exemplary] embodiment of the invention given with reference to the accompanying drawings.

The invention will be further described below in connection to exemplary embodiments which are schematically shown in the drawings, wherein:

FIG. 1 shows a typical electric arc furnace system

FIG. 2 shows a closeup of the above furnace system with tap hole structure and tapping spout runner

FIG. 3 shows an embodiment of a robot

The drawings are illustrative and not necessarily to scale.

### DESCRIPTION OF THE REFERENCE SIGNS

The following reference numbers and signs refer to the drawings:

| | |
|---|---|
| 100 | The system |
| 200 | Furnace body |
| 202 | Electrodes |
| 220 | Furnace sidewall |
| 221 | Sidewall brickwork |
| 222 | Sidewall refractory lining |
| 240 | Tap hole assembly |
| 242 | Tap hole block |
| 244 | Tap hole bore or channel |
| 246 | Taphole channel outlet |
| 248 | Outer cone |
| 252 | Inner cone |
| 254 | Taphole channel inlet |
| 256 | Plugging material |
| 260 | Tapping spout runner |
| 262 | Channel in runner |
| 270 | Floor |
| 271 | Floor brickwork |
| 272 | Furnace bottom refractory lining |
| 280 | Marker |
| 300 | Furnace charge material |
| 302 | Inactive charge |
| 304 | Liquid cavity |
| 306 | Liquid metal |
| 400 | Robot system |
| 410 | Transport means, wheels, belt, rails, track |
| 420 | Arm or articulated arm |
| 422 | Tool installed on arm |
| 430 | Optical system |
| 432 | First camera, on robot arm |
| 440 | Position system for trolley |
| 442 | Position sensor |
| 500 | Ladle |

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The invention will be further described in connection with exemplary embodiments which are schematically shown in the drawings.

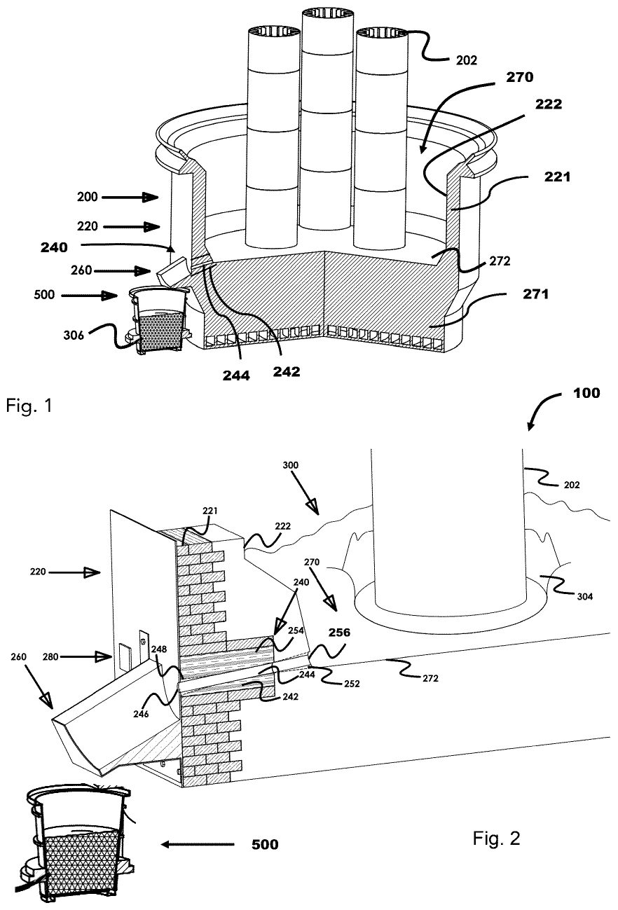

FIG. 1 shows a typical rotating electric arc furnace body 200 according to prior art with electrodes 202 and a furnace sidewall 220 comprising an inner sidewall refractory lining 222 and a floor 270 with a furnace bottom refractory lining 272. The sidewall and furnace bottom refractory lining prevents the melt from attacking the sidewall brickwork 221 and floor brickwork 271. The wall is typically cylindrical around a vertical axis of rotation. Set into the wall at a low position near the floor of the furnace, is the tap hole assembly 240 comprising a tap hole block 242 of a material capable of resisting the aggressive wear and tear of the melt and is typically made of graphite. A tap hole bore 244 or channel runs through the tap hole block 242 to let liquid metal 306 run from the liquid cavity and out of the furnace.

FIG. 2 shows a closeup of the above furnace system 100 with tap hole assembly 240 and a tapping spout runner 260 positioned at the outlet of the tap hole bore 244 or taphole channel outlet 246 of the tap hole bore, that opens to the tapping spout runner 260. When liquid metal 306 from the liquid cavity 304 flows through the tap hole bore 244, the liquid metal pours down along a channel 262 in the tapping spout runner and into a ladle 500. Typically, the tap hole bore is inclined 3-12 degrees so the liquid metal flows downwards, and the channel is also inclined. Tap hole bores are normally plugged with a plugging material 256 to prevent spillage until the furnace is ready for tapping and a ladle is brought into position.

In conventional operations, the furnace rotates slowly and continuously. A plurality of tap hole bores and tapping spout runners are positioned at different positions around the furnace sidewall 220. As the furnace rotates, each tap hole bore and tapping spout runner comes into position for use. Operations are typically in three phases.

In a first phase a new tap hole is opened. A drill is brought into position, and drills through the plugging material 256. It is desirable to control the drilling process, to drill a straight hole, to prevent damage of the tap hole block, and to ensure quick retraction when the drill has reached the liquid metal, to prevent destruction of the drill bit. Misalignment will widen the tap hole bore and/or change the bore from a cylinder shape into a shape with an outer cone 248 and an inner cone 252. Once the drill has reached sufficiently deeply into the plugging material, the last part is removed using an oxygen lance. An operator in heavy protection gear uses a 6 m long metal tube fed with oxygen to burn away the last part of the plugging material and other obstructions so that the flow of liquid metal starts. The heat, smoke, sparks and metal droplets mean a long lance is required. This also means the lance will bend and make guidance difficult, more so when the lance heats up. Poor visibility combined with the continuous rotation of the furnace compounds the problem, and consequently there is significant wear on the tap hole bore, leading to further cone formation, leading to a “trumpet” shape, where the narrow ends of the outer cone 20) 248 and inner cone 252 meet at a narrow area of the tap hole bore.

Once the tap hole is open, the second phase of tapping the liquid metal commences. In this phase, it may be necessary to maintain the tap hole and the tapping spout runner, as the liquid metal flows past and into a ladle 500. This is typically removing solidified metal from the tap hole bore and tapping spout runner that obstruct the flow.

Once the tapping process is completed, the third phase commences. The tap hole bore is filled with a plugging material, typically a form of clay, using a press to extrude the material into the tap hole. The material sets under the heat from the furnace and remains plugged until the process starts anew.

It should be noted that during the second phase the hole may be temporarily plugged. This is a simplified closing and opening process.

### Principles Forming the Basis of the Invention

The inventors have realised that the use of a robot tracking the continuous rotation of the furnace, will be able to locate a marker 280 provided on the furnace sidewall 220 of the furnace body 200. The robot may use a coarse positioning system 410 to align roughly with the tap hole. The robot uses a fine positioning system using optical alignment for fine positioning before operating a tool for opening or plugging the tap hole. The fine positioning system comprises an optical system 430 on the robot and a target positioned on the furnace, wherein an optical system determines the tap hole based on the position of the target.

The optical system determines the spatial position of the robot with respect to the tap hole bore and is thereby able to operate tools at high precision positioning.

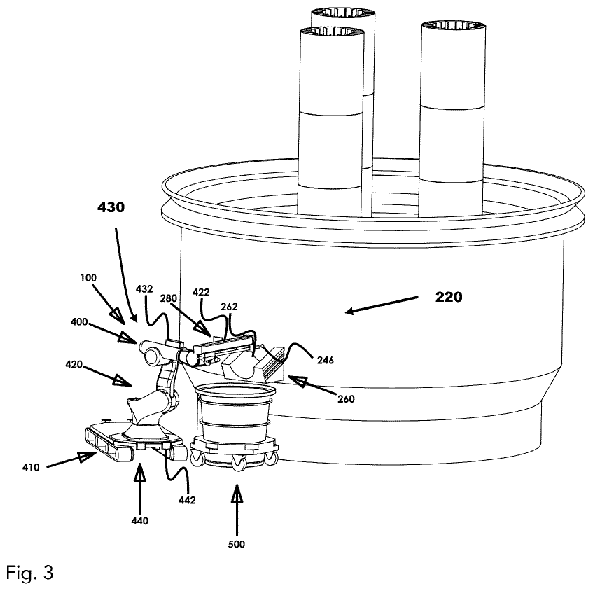

FIG. 3 shows a robot system comprising a fine positioning system, which in turn comprises an arm 420 for operating a tool 422, and an optical system 430. The arm is movable relative to the robot system, and is preferably articulated for flexible operations of the tool.

Once into position, the fine positioning system is engaged. The optical system 430 locates the marker 280 on the furnace sidewall 220 of the rotating furnace. An appropriate tool is selected and brought into position and guided with a precision in the order of a few millimetres.

In the first phase, the tap hole is opened. The drill bit is brought into position by the robot, and drills through the plugging material 256. The drilling process continues until the drill-bit runs into melted metal, then the bit is immediately retracted. The drill is aligned with the tap hole bore and thus avoids having the drill bit from eroding the tap hole block. Misalignment will be minimised and one thereby avoids changing the bore from a cylinder shape into a shape with an outer cone 248 and an inner cone 252. The robot switches to an oxygen lance in the form of a long, typically 6 m long metal tube, fed with oxygen, to make sufficient flow of liquid metal. The heat, smoke, sparks and metal droplets will not disturb the operations of the robot and the operations will be faster than for manual intervention, so a much shorter lance can be used. This also means the lance will bend less than for manual intervention and thus further improve guidance. The effect will be more pronounced when the lance heats up. Poor visibility combined with the continuous rotation of the furnace, will not disturb the robot, since the robot will adjust for the rotation during operation. This too reduces wear on the tap hole bore, that otherwise would lead to further cone formation, leading to a “trumpet” shape, where the narrow ends of the outer cone 248 and inner cone 252 meet at a narrow area of the tap hole bore.

Since the robot knows precisely where to guide the lance, the operations will be much faster and wear out less lance tubing. This saves time, including time to replace the lance.

Once the tap hole is open, the second phase of tapping the liquid metal commences. In this phase, it may be necessary to maintain the tap hole and the channel 262 in the tapping spout runner, as the liquid metal flows past and into a ladle (not shown). The operator can either continue using the oxygen lance or switch to a different tool, such as a scrape, stoking steel and/or wooden beam, in order to maintain the free flow of liquid metal from the tap hole, through the tapping spout runner and into the ladle.

Once the tapping process is completed, the third phase commences. The robot brings a plugging tool into position into the tap hole bore and tap hole bore is filled with a plugging material, typically a form of clay, using a press to extrude the material into the tap hole. The material sets under the heat from the furnace and remains plugged until the process starts anew. The use of the robot ensures uniform processing and that it is known how much plugging material was used. The type of plugging material depends if it is at temporary plugging e.g. when changing ladles, or if it is a permanent plugging e.g. when a tapping hole is rotated away from the tapping zone. A complete rotation of at FeSi furnace takes several weeks, depending on the plant, and differ between plants.

The robot arm 420 is part of the fine positioning system and is movable by the robot with respect to the rotating furnace. The arm holds the tool for the present operations. It is important that the arm positions the tool at the correct position but also that the tool is guided at the correct angle. Typically tap hole bores are inclined by 3-12 degrees, and this angle should be maintained between every operation in order to limit the wear on the furnace. Excessive wear can result in cone and trumpet formation. The angle can be fixed with respect to the arm. In more preferable embodiments, the arm is articulated so the tool can be freely angled in azimuth and/or elevation. This also allows for longer intervals between coarse positioning since the articulation can compensate for the rotation of the furnace.

The robot arm 420 may be provided with a sensor to determine the force applied to the tool being used. This force measurements are valuable data that will be logged for trending and analysis. Even small changes in the trends can be used to determine an upcoming fault or problem.

The operating range of the fine positioning system is limited for a compact robot solution. In this case it may be necessary to repeat coarse positioning also before starting the second and/or third phase.

It has been found that the present invention can be used for adding fining to ladle during the tapping process. Typically the robot holds a container that adds fining material to the top of the ladle 500 and/or to the material as it flows down the channel in the runner. By adding material in the runner, the mixing is achieved prior to the oxygen treatment in the ladle, and can also improve homogeneity. The robot can come much closer to the ladle than a human operator safely can, and add material in a controlled manner. At the same time, the robot camera system can monitor the ladle and runner during the process.

### Best Modes of Carrying out the Invention

A preferred embodiment of the apparatus according to the invention is shown in FIG. 3 and comprises a first means for coarse positioning such as a trolley 440 with wheels or tracks 410. The wheels may be wheels running along a dedicated track. The main advantage of the coarse positioning system is to move the system in the tapping area, and quickly position the robot in a suitable position relative to the furnace. An operator uses a remote control to position the robot in a suitable area, taking the rotation of the furnace into account. It is strongly preferred that the fine positioning system can compensate for the furnace rotation in all phases of the operation without having to restart the coarse positioning system.

Preferably the coarse positioning system 440 is provided with a position sensor 442 for quick positioning into the working area.

### Alternative Embodiments

A number of variations on the above can be envisaged. For instance, the system can operate without a coarse positioning system by being positioned at a fixed point and using a fine positioning system with a long working range, sufficient to cover the span of positions of the tap hole for the duration of tapping operation as the furnace turns.

It is preferred that individually recognisable markers are used for each tap hole location. It is likely that the markers will not be positioned with the millimetre level of positioning that the present invention permits, so the control system can instead be provided with appropriate offset values for each tap hole. Also, when the furnace is serviced and the tap hole assembly 240 is replaced, a recalibration can conveniently be performed as the tap hole bore is clean, and operators can make adjustments and calibrations without the dangers from a hot furnace in operation. This allows further improvement in tap hole service life.

While a wheeled or tracked robot is beneficial in that the coarse positioning can be used to remove the robot from the working area, it should be noted that coarse positioning is not a requirement for the invention to work. In alternative embodiments, the robot can be fixed to a position in the working area, such as the floor, ceiling, walls or pillars or the like, and use an extended arm for fine positioning only.

Preferably when not in use the arm can move the tools to a position away from the working area to avoid heat, sparks and metal droplets.

While the robot can operate a plurality of tools from the group comprising a drill bit, oxygen lance, punch and clay gun; it is also possible to have the robot use one fixed tool such as a tool from above group of tools.

While the robot can operate a plurality of tools based on positioning, it is also possible to use the camera system for further purposes such as to verify that the right tool is in position, that the tool extends to its intended position, and/or that the tool is in need of repair or replacement. Wear of tools can be monitored every time it is retracted from the bore hold.

Further sensors can be used by the robot, such as thermal sensors, to determine the status of the furnace based on the surface temperature. In a variation, an acoustic sensor can be used to monitor the sound of the tool being operated or the damping of the sound coming from the charge material of the furnace. A mechanical sensor or gauge can be used to calibrate the position of the hole with respect to the camera system to ensure correct alignment.

During operations, the tap hole block may sag and thereby deform the tap hole bore. This can be compensated by several means such as manual adjustment or optical recognition of the tap hole bore opening using cameras, separately or in combination. Thermal cameras can be used to identify the tap hole since the thermal profile will differ, especially if the tap hole bore is temporarily plugged.

### INDUSTRIAL APPLICABILITY

The invention according to the application finds use in operating on tap holes for rotating furnaces.

1. A robot system (400) for operating a rotating arc furnace (200),
wherein the rotating furnace comprises
a furnace sidewall (220) and a floor (270) defining a container for holding a charge material (300) of liquid metal (306), and
a tap hole assembly (240) within the furnace sidewall (220), wherein the tap hole assembly comprises a tap hole block (242) wherein a tap hole bore (244) or channel runs through the tap hole block (242) to let the liquid metal (306) flow from the charge material (300), and out of the furnace body (200),
wherein a marker (280) is provided on the furnace sidewall (220) of the furnace body (200),
characterised in that the robot system further comprises and arm (420) for operating a tool (422) and a fine positioning system comprising
an optical system (430),
wherein the fine positioning system uses optical system (430) to track the marker (280) to position the arm (420), thus guiding the tool (422) with respect to the tap hole assembly (240).

2. The robot system according to claim 1, further comprising a coarse positioning system (410), for use prior to the fine positioning system.

3. The robot system according to claim 1, wherein the optical system (430) comprises two cameras for stereo imaging.

4. The robot system according to claim 1, wherein the marker (280) identifies the tap hole assembly from a plurality of tap hole assemblies, and is used for retrieving calibration data for guiding the tool with respect to the tap hole assembly.

30.

5. A method for operating a robot system (400) for operating a rotating arc furnace (200) according to claim 1,
wherein the rotating furnace comprises
a furnace sidewall (220) and a floor (270), defining a container for holding a charge material (300) of liquid metal (306), and
a tap hole assembly (240) within the furnace sidewall (220), wherein the tap hole assembly comprises a tap hole block (242) wherein a tap hole bore (244) or channel runs through the tap hole block (242) to let the liquid metal (306) flow from the charge material (300), and out of the furnace body (200),
characterised in that a marker (280) is provided on the furnace sidewall (220) of the furnace body (200),
wherein the robot system further comprises
an arm (420) for operating a tool (422), and a fine positioning system comprising
an optical system (430),
wherein the method comprises:
using the optical system (430) to track the marker (280),
positioning the arm (420) with respect to the marker (280), thus guiding the tool (422) with respect to the tap hole assembly (240).

6. The method according to claim 5, further comprising the step of identifying the specific marker (280) and applying offset calibration specific to the marker (280) prior to positioning the arm.
